(19) United States
(12) Patent Application Publication
(10) Pub. No.: US 2024/0254037 A1
(43) Pub. Date: Aug. 1, 2024

(54) WINDOW GLASS FOR VEHICLE AND METHOD FOR MANUFACTURING SAME, LAMINATED GLASS FOR VEHICLE, AND WINDSHIELD FOR VEHICLE

(71) Applicant: AGC Inc., Tokyo (JP)

(72) Inventors: Jun ITO, Tokyo (JP); Keiichiro URAJI, Tokyo (JP); Shunsuke SADAKANE, Tokyo (JP); Hiroki FUJIMOTO, Tokyo (JP); Yuukou MINAMIYA, Tokyo (JP); Ayaka IKEGAMI, Tokyo (JP)

(73) Assignee: AGC Inc., Tokyo (JP)

(21) Appl. No.: 18/627,442

(22) Filed: Apr. 5, 2024

Related U.S. Application Data
(63) Continuation of application No. PCT/JP2022/037021, filed on Oct. 3, 2022.

(30) Foreign Application Priority Data
Oct. 6, 2021 (JP) 2021-165065

(51) Int. Cl. C03C 17/42; B60J 1/00; C03C 4/02; C03C 17/00

(52) U.S. Cl. CPC C03C 17/42; C03C 4/02; C03C 17/002; B60J 1/00; C03C 2203/52; C03C 2217/485

(57) ABSTRACT

A window glass for a vehicle includes: a glass plate having a first main surface and a second main surface; a ceramic color layer, and an organic ink layer, in which the ceramic color layer is provided at least in a periphery on the first main surface of the glass plate, the organic ink layer is provided to cover at least a partial region on the ceramic color layer provided in the periphery, and a thickness of the organic ink layer is smaller than a thickness of the ceramic color layer.

### CROSS-REFERENCE TO RELATED APPLICATIONS

This is a bypass continuation of International Patent Application No. PCT/JP2022/037021, filed on Oct. 3, 2022, which claims priority to Japanese Patent Application No. 2021-165065, filed on Oct. 6, 2021. The contents of these applications are hereby incorporated by reference in their entireties.

### TECHNICAL FIELD

The present invention relates to a window glass for a vehicle and a manufacturing method therefor, and also relates to a laminated glass for a vehicle and a windshield for a vehicle.

### BACKGROUND ART

In a window glass for a vehicle such as an automobile or the like, a ceramic color layer, which is a colored opaque layer, may be formed in a periphery of a glass plate.

With the ceramic color layer, adhesives such as a urethane sealant that bond and hold the glass plate and an automobile body can be prevented from deteriorating due to ultraviolet rays. In addition, the ceramic color layer also plays the role of concealing a portion where the adhesive sticks out, a conductive layer such as an antenna or a heating wire formed in the periphery of the glass plate, or mounted parts such as a mirror base and a bracket that are bonded to the glass plate to prevent the same to be visually recognized from outside the vehicle. Further, for the purpose of improving the design, it may be a ceramic color layer in which, for example, a fine dot pattern is formed in a gradation manner.

A ceramic color composition, which is a precursor of the ceramic color layer, is known to be based on a glass powder and mixed with various heat-resistant pigments. The glass powder may be based on an amorphous glass powder that does not crystallize during glass baking, or a crystalline glass powder that crystallizes during glass baking.

For example, Patent Literature 1 discloses a ceramic color composition containing 50 wt % to 90 wt % of a zinc-containing low-melting glass powder having a specific composition that does not contain harmful metals such as lead, 10 wt % to 40 wt % of an inorganic pigment powder, and 0 wt % to 10 wt % of an inorganic filler powder.

In addition, Patent Literature 2 discloses a ceramic color composition containing a lead-free glass powder containing Bi₂O₃ and SiO₂ as main components, 0.05 wt % to 9.95 wt % of MgO, and 0.05 wt % to 9.95 wt % of BaO, in which a total content of MgO and BaO is 0.1 wt % to 10 wt %.

### CITATION LIST

### Patent Literature

Patent Literature 1: JPH11-157873A
Patent Literature 2: JP2008-266056A

### SUMMARY OF INVENTION

The ceramic color layer is formed by applying the ceramic color composition onto a main surface of the glass plate, followed by a heat treatment and firing. However, when the ceramic color layer is formed, strength of the window glass for a vehicle decreases.

Therefore, an object of the present invention is to provide a window glass for a vehicle in which a ceramic color layer is formed and a decrease in strength is prevented, and a manufacturing method therefor.

As a result of intensive studies, the inventors of the present invention have found that the decrease in strength of the window glass for a vehicle due to the formation of the ceramic color layer is partly due to stress concentration caused by surface roughness of the ceramic color layer. With respect to this, when at least a partial region on the ceramic color layer is covered with an organic ink layer, the surface thereof is smoothed, the stress concentration is alleviated, and the above problem can be solved.

That is, the present invention relates to the following [1] to [16].

[1] A window glass for a vehicle including:
a glass plate having a first main surface and a second main surface;
a ceramic color layer; and
an organic ink layer, in which
the ceramic color layer is provided at least in a periphery on the first main surface of the glass plate,
the organic ink layer is provided to cover at least a partial region on the ceramic color layer provided in the periphery, and
a thickness of the organic ink layer is smaller than a thickness of the ceramic color layer.

[2] The window glass for a vehicle according to the above [1], in which the ceramic color layer has a surface roughness Ra of 0.25 μm or more.

[3] The window glass for a vehicle according to the above [1], in which the glass plate has a curved surface shape in which the first main surface is concave, and the organic ink layer is provided to further cover a partial region on the first main surface of the glass plate, as well as a boundary portion between the glass plate and the ceramic color layer provided in the periphery.

[4] The window glass for a vehicle according to the above [1], in which an outer edge region where the ceramic color layer is not formed is present between an outer peripheral end of the first main surface of the glass plate and an outer peripheral end of the ceramic color layer provided in the periphery, and the organic ink layer is provided in the outer edge region.

[5] The window glass for a vehicle according to the above [1], in which the thickness of the ceramic color layer is 6 μm to 30 μm, and the thickness of the organic ink layer is 1 μm to 10 μm.

[6] The window glass for a vehicle according to the above [1], in which the window glass is configured to be disposed in a vehicle such that the first main surface of the glass plate is on a vehicle inner side and the second main surface of the glass plate is on a vehicle outer side.

[7] A laminated glass for a vehicle including: the window glass for a vehicle according to any one of the above [1] to [6].

[8] A windshield for a vehicle including: the window glass for a vehicle according to any one of the above [1] to [6].

[9] A windshield for a vehicle including: the laminated glass for a vehicle according to the above [7].

[10] A method for manufacturing a window glass for a vehicle, sequentially including: preparing a glass plate having a first main surface and a second main surface; applying a pasty ceramic color composition to at least a periphery on the first main surface of the glass plate and performing a heat treatment to form a ceramic color layer; and applying an organic ink composition to cover at least a partial region on the ceramic color layer provided in the periphery, and curing the organic ink composition to form an organic ink layer.

[11] The method for manufacturing a window glass for a vehicle according to the above [10], in which the heat treatment is performed at a firing temperature equal to or higher than an annealing point of the glass plate while the glass plate is also bent and molded.

[12] The method for manufacturing a window glass for a vehicle according to the above or [11], in which the organic ink layer is formed to also cover a partial region on the first main surface of the glass plate, as well as a boundary portion between the glass plate and the ceramic color layer provided in the periphery.

[13] The method for manufacturing a window glass for a vehicle according to the above or [11], in which the organic ink composition is applied by an inkjet printing.

[14] The method for manufacturing a window glass for a vehicle according to the above or [11], in which the ceramic color layer is formed such that an outer edge region where the ceramic color layer is not formed is present between an outer peripheral end of the first main surface of the glass plate and an outer peripheral end of the ceramic color layer, and the organic ink layer is formed in the outer edge region.

[15] The method for manufacturing a window glass for a vehicle according to the above or [11], in which the organic ink layer is formed by thermal curing or photocuring of the organic ink composition.

[16] The method for manufacturing a window glass for a vehicle according to the above or [11], in which the organic ink layer is formed by thermal curing of the organic ink composition, and the thermal curing is performed at a heat treatment temperature lower than the firing temperature equal to or higher than the annealing point of the glass plate.

According to the present invention, at least a partial region on the ceramic color layer is covered with the organic ink layer, and thereby the surface is smoothed. Therefore, stress concentration caused by surface roughness is alleviated, and a decrease in strength of the window glass for a vehicle can be prevented.

### BRIEF DESCRIPTION OF DRAWINGS

FIG. 1 is a schematic diagram showing an example of a window glass for a vehicle according to the present embodiment.

FIG. 2 is a schematic cross-sectional view showing an example of a part of the window glass for a vehicle according to the present embodiment.

FIG. 3 is a schematic cross-sectional view showing an example of a part of the window glass for a vehicle according to the present embodiment.

FIG. 4 is a schematic cross-sectional view showing an example of a part of the window glass for a vehicle according to the present embodiment.

FIG. 5 is a schematic cross-sectional view showing an example of a part of the window glass for a vehicle according to the present embodiment.

FIG. 6 is a schematic cross-sectional view showing an example of a part of the window glass for a vehicle according to the present embodiment.

FIG. 7 is a schematic cross-sectional view showing an example of a part of the window glass for a vehicle according to the present embodiment.

FIG. 8 is a schematic diagram showing an example of the vicinity of an information transmission and reception region of the window glass for a vehicle according to the present embodiment.

FIG. 9 is a schematic diagram showing an example of the vicinity of the information transmission and reception region of the window glass for a vehicle according to the present embodiment.

FIG. 10 is an FE-SEM image of a small piece of a window glass for a vehicle in Example 1.

FIG. 11 is an FE-SEM image of a small piece of a window glass for a vehicle in Example 2.

FIG. 12 is an FE-SEM image of a small piece of a window glass for a vehicle in Example 3.

FIG. 13 is an FE-SEM image of a small piece of a window glass for a vehicle in Example 4.

### DESCRIPTION OF EMBODIMENTS

Hereinafter, the present invention will be described in detail, but the present invention is not limited to the following embodiment and can be freely modified and implemented without departing from the gist of the present invention. In addition, the symbol “-” or the word “to” that is used to express a numerical range includes the numerical values before and after the symbol or the word as the upper limit and the lower limit of the range, respectively.

### <Window Glass For a Vehicle>

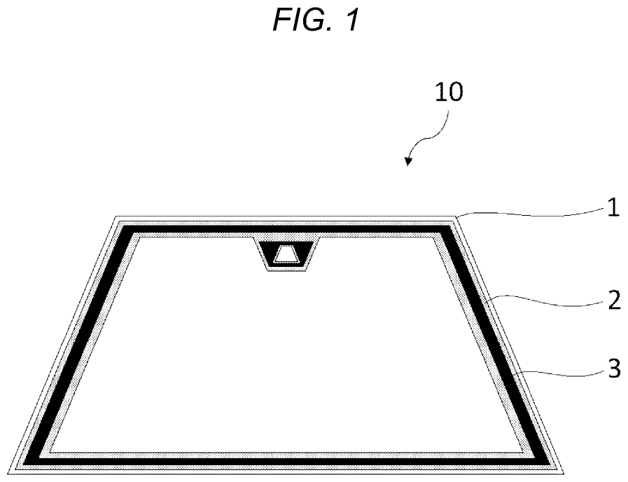

In a window glass 10 for a vehicle according to the present embodiment, a glass plate 1 has a first main surface 1a and a second main surface 1b, and as shown in FIG. 1, a ceramic color layer 2 is provided at least in a periphery on the first main surface of the glass plate. In addition, an organic ink layer 3 is provided to cover at least a partial region on the ceramic color layer 2 provided in the periphery. A thickness of the organic ink layer 3 is smaller than a thickness of the ceramic color layer 2.

When the ceramic color layer is formed, strength of the window glass for a vehicle decreases. With respect to this, when the organic ink layer is provided on a surface of the ceramic color layer, such a decrease in strength can be prevented.

The decrease in strength due to the formation of the ceramic color layer is considered to be caused by the fact that the ceramic color layer is a layer that is fired at a high temperature. That is, the surface of the ceramic color layer is rough and uneven, and a stress tends to concentrate due to the surface roughness, which is considered to decrease the strength of the window glass for a vehicle.

With respect to this, when at least a partial region on the ceramic color layer is covered with the organic ink layer, the surface can be smoothed. This is because an organic ink composition, which is a precursor of the organic ink layer, is a liquid. That is, the organic ink composition penetrates unevenness on the surface of the ceramic color layer, particularly recessed portions, and the entire surface is smoothed. It is considered that this smoothing alleviates concentration of the stress, and as a result, the decrease in strength of the window glass for a vehicle can be prevented.

The ceramic color layer may be provided at least in the periphery on the first main surface of the glass plate, or may be provided in a region other than the periphery.

The periphery of the first main surface of the glass plate means a region present along an outer periphery of the first main surface of the glass plate and near the outer periphery. However, the ceramic color layer does not have to be provided in an outermost edge region, that is, outermost on the on the first main surface. For example, it is sufficient that the ceramic color layer is provided in a region within 1.5 mm from the outer periphery of the first main surface.

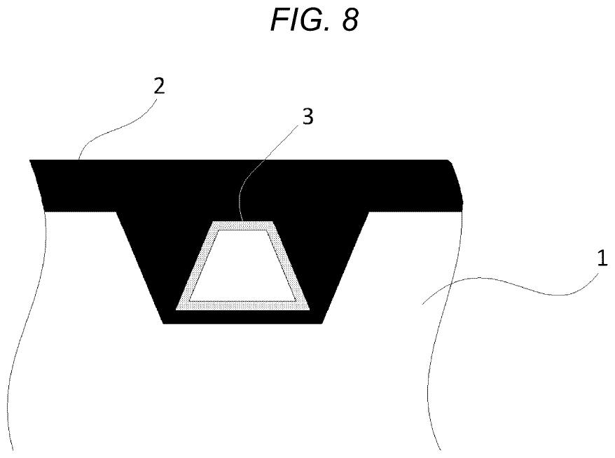

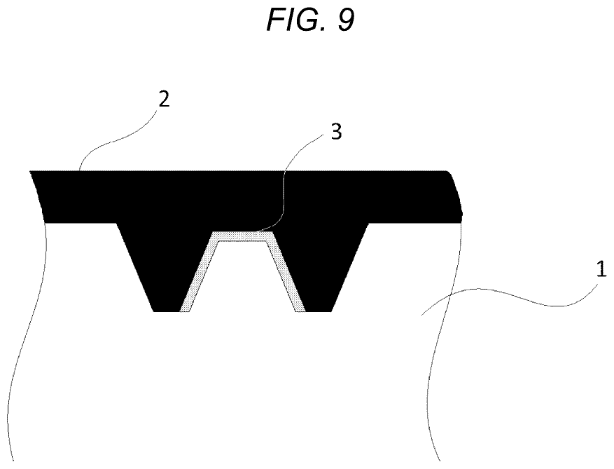

In addition, the region other than the periphery may be provided, for example, in a peripheral portion of an information transmission and reception region through which a signal transmitted and received by an information communication device mounted in an interior of the vehicle, such as a camera and a radar, passes. The information transmission and reception region is a region different from the periphery, and is a region through which a signal such as electromagnetic waves transmitted and received by the information communication device passes. For example, in FIG. 1, it is a small trapezoidal region separated by the organic ink layer 3 on a top portion of the window glass for a vehicle. As shown in FIG. 1 or FIG. 8, this information transmission and reception region may be separated to be independent by being entirely surrounded by the organic ink layer 3. In addition, as shown in FIG. 9, all sides of the information transmission and reception region does not necessarily need to be surrounded by the organic ink layer 3 so that the information transmission and reception region is independent. Three sides of the information transmission and reception region may be surrounded by the organic ink layer 3.

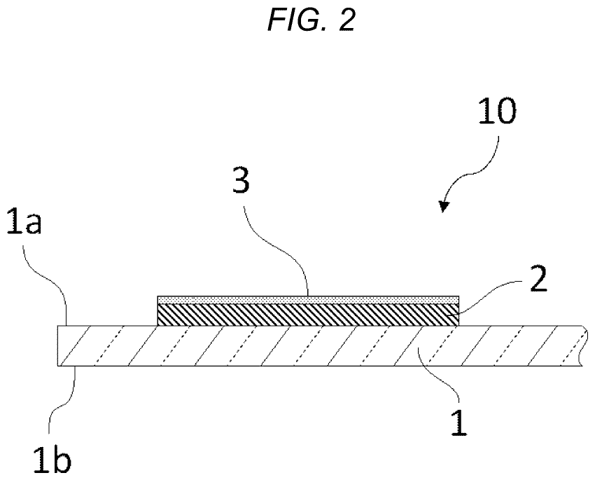

Regarding a relationship between the ceramic color layer and the organic ink layer, FIG. 2 to FIG. 7 each show a schematic cross-sectional view as an example of a part of the window glass for a vehicle.

In FIG. 2, the organic ink layer 3 is provided to cover the entire region of the ceramic color layer 2. Accordingly, the unevenness on the surface of the ceramic color layer 2 is covered and smoothed over the entire region, so that a higher strength of the window glass for a vehicle is achieved.

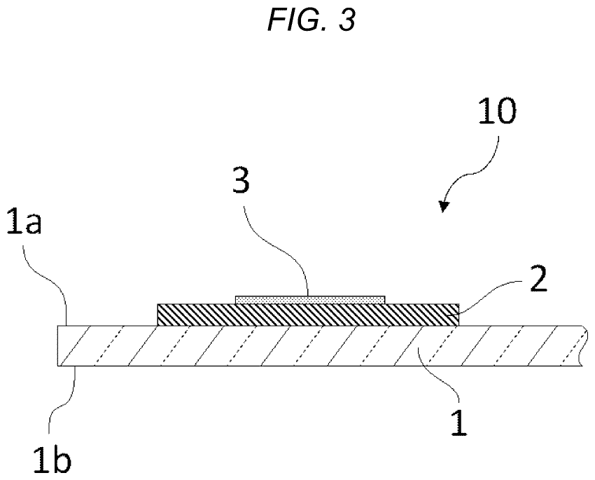

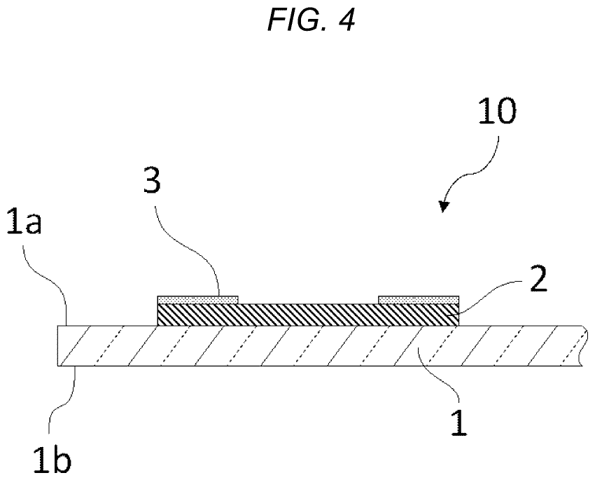

In FIG. 3 and FIG. 4, a partial region on the ceramic color layer 2 is covered with the organic ink layer 3. Compared to the ceramic color layer 2, the organic ink layer 3 has a poor adhesiveness to adhesives such as a urethane sealant commonly used for the window glass for a vehicle, or a poor adhesiveness in the case of forming a conductive layer such as an antenna or a heating wire on the window glass for a vehicle. Therefore, in the case of forming the adhesive or conductive layer, it is preferable to leave a region on the ceramic color layer 2 where the organic ink layer 3 is not provided.

Note that, in the case of further forming a conductive layer on the ceramic color layer 2, not only the ceramic color layer 2 but also a partial region on the conductive layer may be covered with the organic ink layer 3. That is, the conductive layer includes functional units such as an antenna unit for transmitting and receiving radio waves and a heat generating unit for generating heat by flowing a current, and a power supply unit for supplying power and signals to the functional unit. Since terminals are connected to the power supply unit using lead-free solder or the like, when the power supply unit is covered with the organic ink layer 3, the terminals cannot be connected to the power supply unit. Therefore, when a conductive layer is formed on the ceramic color layer 2, at least a portion of the ceramic color layer 2 and at least a portion of the functional unit of the conductive layer may be covered with the organic ink layer 3. In addition, a metal terminal may be connected to the power supply unit of the conductive layer using lead-free solder.

A degree for the organic ink layer 3 to cover the ceramic color layer 2, that is, the width at which the organic ink layer 3 and the ceramic color layer 2 overlap each other is not particularly limited, and a degree to which the organic ink layer and the ceramic color layer overlap each other can be determined according to desired characteristics.

For example, the width of the ceramic color layer not covered with the organic ink layer is preferably 5 mm to 20 mm, and more preferably 10 mm to 15 mm. Here, from the viewpoint of the adhesiveness in the case of applying an adhesive such as urethane or providing a conductive layer, or the like, to the ceramic color layer, as shown in FIG. 3 or FIG. 4, it is preferable that there be a region on the ceramic color layer not covered with the organic ink layer, and the width of the ceramic color layer not covered with the organic ink layer is preferably 5 mm or more, and more preferably 10 mm or more. On the other hand, from the viewpoint of improving the strength of the window glass for a vehicle, the width of the ceramic color layer not covered with the organic ink layer is preferably 20 mm or less, and more preferably 15 mm or less. As shown in FIG. 2, the entire surface of the ceramic color layer may be covered with the organic ink layer. Note that, the width of the region of the ceramic color layer not covered with the organic ink layer does not need to be constant, and the above region may not be a band-like region having a constant width, but may be an island-like region that is present independently.

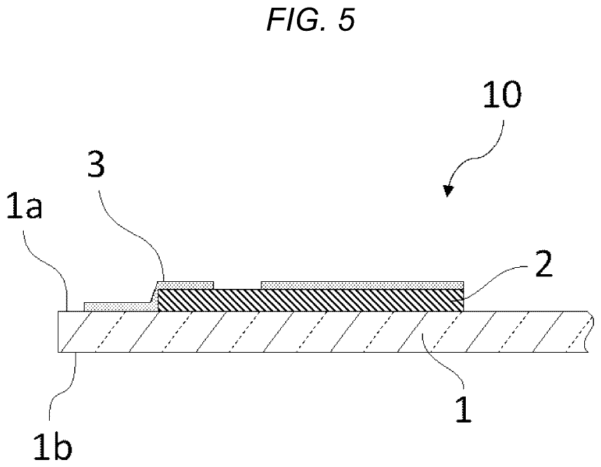

In FIG. 5, the organic ink layer 3 is provided to further cover a partial region on the first main surface 1a of the glass plate 1, as well as a boundary portion between the glass plate 1 and the ceramic color layer 2.

The ceramic color layer absorbs light in an infrared region. Therefore, when a heat treatment to form the ceramic color layer is performed at a high temperature enough to bend and mold the glass plate, a deviation occurs in degree of expansion and contraction of the glass plate between a region where the ceramic color layer is formed and a region where the ceramic color layer is not formed of the glass plate. That is, a distortion occurs in the glass plate around the boundary portion between these regions.

With respect to this, as shown in FIG. 5, when the organic ink layer is provided to cover the boundary portion where the distortion occurs in the glass plate, the strength of the window glass for a vehicle is improved, and the above distortion can be concealed.

Concealment of the distortion at the periphery of the glass plate is preferred from the viewpoint of design.

In addition, when there is a distortion in the information transmission and reception region through which a signal transmitted and received by the information communication device passes, the signal transmitted and received by the information communication device is not transmitted accurately. For example, when the information communication device is a camera, it causes the image to be distorted, and when it is a laser radar, it causes an optical axis to be deviated. Therefore, concealment of the distortion in the information transmission and reception region is preferred from the viewpoint of accurately transmitting a signal transmitted and received by the information communication device.

Note that, performing the heat treatment to form the ceramic color layer at a high temperature enough to bend and mold the glass plate means to form the ceramic color layer by performing a heat treatment at a firing temperature equal to or higher than an annealing point of the glass plate. In this case, from the viewpoint of productivity, it is preferable to perform bending and molding of the glass plate at the same time as formation of the ceramic color layer, and it is more preferable to perform bending and molding such that the glass plate has a curved surface shape in which the first main surface is concave.

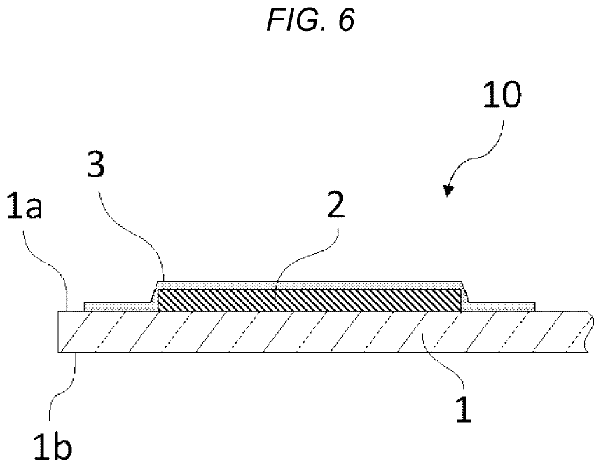

FIG. 6 shows an example in which the organic ink layer 3 is provided to further cover a partial region on the first main surface 1a of the glass plate 1, as well as a boundary portion between the glass plate 1 and the ceramic color layer 2, at both an inner peripheral end and an outer peripheral end of the ceramic color layer.

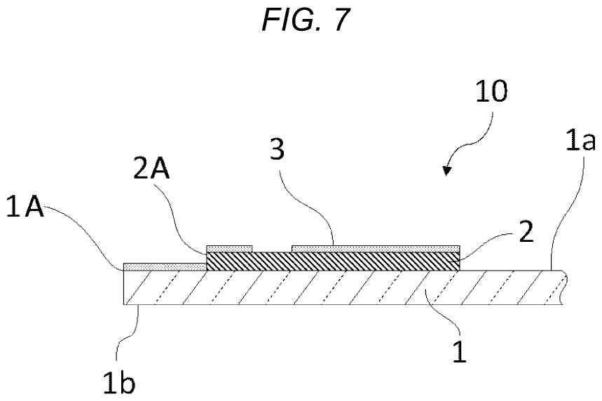

In FIG. 7, an outer edge region where the ceramic color layer is not formed is present between an outer peripheral end 1A of the first main surface 1a of the glass plate 1 and an outer peripheral end 2A of the ceramic color layer 2 provided in the periphery on the first main surface 1a of the glass plate 1, and the organic ink layer 3 is also provided in the outer edge region.

The above outer edge region on the first main surface 1a of the glass plate 1 has strength smaller than another region. When it is attempted to provide the ceramic color layer 2 in this outer edge region from the viewpoint of design, the strength of the outer edge region further decreases. With respect to this, when the organic ink layer 3 is provided in the outer edge region instead of the ceramic color layer 2, compared to the case where the ceramic color layer 2 is provided, a decrease in strength in the outer edge region can be prevented.

In addition, in the case of a laminated glass for a vehicle including the window glass for a vehicle, an interlayer used in bonding the glasses is interposed up to the outer edge region of the laminated glass. It is preferable to form the organic ink layer in the outer edge region also for the purpose of concealing discoloration due to deterioration of the interlayer. Note that, generally, the ceramic color layer is formed by applying a pasty ceramic color composition, which will be described later, by using a screen printing method. Therefore, it is difficult to provide the ceramic color layer in the outer edge region in terms of the printing method, but since the organic ink layer can be formed by applying and curing an organic ink composition by using an inkjet printing method, it can also be easily formed on the outer edge region.

Note that, in FIG. 7, the organic ink layer 3 that covers the ceramic color layer 2 and the organic ink layer 3 that directly covers the first main surface 1a of the glass plate 1 are formed discontinuously. Alternatively, as shown in FIG. 5 and FIG. 6, the organic ink layer 3 may be formed continuously. Similarly, in FIG. 5 and FIG. 6, the organic ink layer 3 that covers the ceramic color layer 2 and the organic ink layer 3 that directly covers the first main surface 1a of the glass plate 1 are formed continuously. Alternatively, as shown in FIG. 7, the organic ink layer 3 may be formed discontinuously.

An end surface of the glass plate may be chamfered. In this case, the outer edge region refers to a region between the outer peripheral end of the first main surface of the glass plate and the outer peripheral end of the ceramic color layer, which is a non-chamfered region.

In the window glass for a vehicle according to the present embodiment, a static load strength of a region where the ceramic color layer and the organic ink layer are formed on the glass plate is preferably 1.2 times or more with respect to a static load strength of a region where only the ceramic color layer is formed on the glass plate. The upper limit is not particularly limited, and is generally 3 times or less.

Note that, the static load strength in the present description is a value obtained by a ring-on-ring test performed under the following conditions.

In the ring-on-ring test, the window glass for a vehicle is placed on a ring having a diameter of 98 mm such that the first main surface of the glass plate faces downward, and a ring having a diameter of 46 mm is placed thereon. Thereafter, a load is applied from above at a rate of 1 mm/min, and the load when the window glass for a vehicle is broken is measured. Such a test is performed at least seven times, and the average value is taken as the static load strength of the window glass for a vehicle.

The window glass for a vehicle according to the present embodiment may be formed with a conductive layer or a solder layer in addition to the ceramic color layer and the organic ink layer. Further, as long as the effect of the present invention is not impaired, a low reflection film layer, a heat insulating film layer, a UV (ultraviolet light) cutting film layer, or the like may be provided in a transparent region of the window glass for a vehicle where the ceramic color layer is not formed. For these, respective known layers can be formed using known methods.

The window glass for a vehicle according to the present embodiment may be a laminated glass for a vehicle bonded to one or more other glass plates via an interlayer. The one or more other glass plates may be the same as or different from the glass plate in the present embodiment.

By making the window glass for a vehicle into the laminated glass for a vehicle, it is suitably used mainly for a windshield for an automobile and a roof glass for an automobile.

It is sufficient that at least one of the glass plates used in the laminated glass for a vehicle is the window glass for a vehicle according to the present embodiment provided with a ceramic color layer and an organic ink layer, and other glass plates may be different from the window glass for a vehicle according to the present embodiment.

The number of glass plates constituting the laminated glass for a vehicle may be two or more, and from the viewpoint of weight reduction, two is more preferred.

The thicknesses of the two or more glass plates used in the laminated glass for a vehicle may be the same as or different from each other.

The window glass for a vehicle according to the present embodiment is particularly preferably used as a windshield for a vehicle, and more preferably used as a windshield for an automobile. In addition, it is also preferable to use the window glass for a vehicle as a windshield for a vehicle, and more preferably to use the window glass for a vehicle as a windshield for an automobile, while being used as the above laminated glass for a vehicle.

A material for the interlayer used in the laminated glass for a vehicle is not particularly limited, and for example, a thermoplastic resin is preferred.

Examples of the thermoplastic resin include a plasticized polyvinyl acetal-based resin, a plasticized polyvinyl chloride-based resin, a saturated polyester-based resin, a plasticized saturated polyester-based resin, a polyurethane-based resin, a plasticized polyurethane-based resin, an ethylene-vinyl acetate-based copolymer resin, an ethylene-ethyl acrylate-based copolymer resin, a cycloolefin polymer resin, and an ionomer resin. In addition, a resin composition containing a modified block copolymer hydride described in JP6065221B can also be suitably used.

The thermoplastic resins may be used alone or in combination of two or more types thereof. In addition, the expression “plasticized” means that plasticization is performed by addition of a plasticizer. In addition, the material for the interlayer may be a resin containing no plasticizer, such as an ethylene-vinyl acetate copolymer-based resin.

Among them, a plasticized polyvinyl acetal-based resin is more preferred since it is excellent in balance among various performances such as transparency, weather resistance, strength, adhesive force, penetration resistance, impact energy absorbability, moisture resistance, heat shielding properties, and sound insulating properties.

Examples of the polyvinyl acetal-based resin include a polyvinyl formal resin obtained by reacting polyvinyl alcohol (PVA) with formaldehyde, a polyvinyl acetal-based resin in a narrow sense obtained by reacting PVA with acetaldehyde, and a polyvinyl butyral resin (PVB) obtained by reacting PVA with n-butyraldehyde. Particularly, PVB is more preferred since it is excellent in balance among various performances such as transparency, weather resistance, strength, adhesive force, penetration resistance, impact energy absorbability, moisture resistance, heat shielding properties, and sound insulating properties. Note that, these polyvinyl acetal-based resins may be used alone or in combination of two or more types thereof.

### (Organic Ink Layer)

As described above, the organic ink layer is provided to cover at least a partial region on the ceramic color layer provided in the periphery on the first main surface of the glass plate. Accordingly, the uneven surface of the ceramic color layer is smoothed. As a result, it is possible to prevent the window glass for a vehicle from breaking due to the stress concentration.

The organic ink layer may further be provided to cover the ceramic color layer provided in a region other than the periphery, or may be provided directly on the first main surface of the glass plate without the ceramic color layer.

Among them, it is preferable that the organic ink layer be provided to further cover a partial region on the first main surface of the glass plate, as well as a boundary portion between the glass plate and the ceramic color layer provided in the periphery. Accordingly, even when there is a distortion in the glass plate at the above boundary portion, the distortion can be concealed, the design can be improved, and a signal transmitted and received by the information communication device can be transmitted accurately.

It is preferable that the organic ink layer be also provided in an outer edge region where the ceramic color layer is not formed, which is between the outer peripheral end of the first main surface of the glass plate and the outer peripheral end of the ceramic color layer provided in the periphery on the first main surface of the glass plate. Accordingly, the design is improved, and breaking can be prevented compared to the case where the ceramic color layer is formed in the outer edge region.

Note that, when the ceramic color layer is provided in the outer edge region, the strength of the glass plate decreases due to a residual stress derived from the ceramic color layer. However, unlike the ceramic color layer, the organic ink layer can be formed separately after the formation of the ceramic color layer or the bending and molding of the glass plate, without requiring firing at a high temperature. Therefore, the residual stress derived from the organic ink layer is lower than the residual stress derived from the ceramic color layer, and a decrease in strength can be prevented compared to the case where the ceramic color layer is formed in the outer edge region.

The organic ink layer is formed by applying an organic ink composition, which is a precursor of the organic ink layer, to a desired region on the first main surface of the glass plate or the surface of the ceramic color layer by printing or the like, and then curing the organic ink composition. Note that, the organic ink composition is a composition containing a coloring material that is an organic coloring agent such as an organic pigment or an organic dye.

When the ceramic color layer is covered with the organic ink layer, surface roughness Ra is reduced, and the strength of the window glass for a vehicle is improved. Specifically, it is preferable that the surface roughness Ra of the organic ink layer provided on the ceramic color layer be smaller than the surface roughness Ra of the ceramic color layer not covered with the organic ink layer.

The surface roughness Ra of the organic ink layer provided on the ceramic color layer varies depending on the surface roughness Ra of the ceramic color layer, and is preferably 0.2 μm or less, and more preferably 0.15 μm or less. The lower limit of the surface roughness Ra of the organic ink layer provided on the ceramic color layer is not particularly limited, and is generally 0.1 μm or more.

The surface roughness Ra of the organic ink layer is obtained by stylus measurement using a surface roughness measuring device in accordance with JIS B 0601 (1994).

Qualitatively, by cross-sectional observation using a scanning electron microscope (SEM), it can be confirmed that the surface of the ceramic color layer covered with the organic ink layer is smoother than the surface of the ceramic color layer. Similarly, by a cross-sectional profile using a white interference microscopy, it can also be confirmed that the surface of the ceramic color layer covered with the organic ink layer is smoother than the surface of the ceramic color layer.

A thickness of the organic ink layer is preferably 1 μm to 30 μm, more preferably 1 μm to 20 μm, still more preferably 1 μm to 15 μm, and particularly preferably 1 μm to 10 μm. Here, the thickness of the organic ink layer can be made smaller than the thickness of the ceramic color layer, which is excellent in terms of quality control. In addition, when the thickness of the organic ink layer is made smaller, it is easier to distinguish the boundary with the ceramic color layer. From these viewpoints, the thickness of the organic ink layer is preferably 30 μm or less, more preferably 20 μm or less, still more preferably 15 μm or less, and particularly preferably 10 μm or less. In addition, from the viewpoint of preventing defects such as holes, the thickness of the organic ink layer is preferably 1 μm or more.

In addition, a difference between the thickness of the organic ink layer and the thickness of the ceramic color layer is preferably 1 μm or more, more preferably 3 μm or more, and still more preferably 5 μm or more. There is no upper limit to the difference in thickness, and it is, for example, 20 μm or less.

The thickness of the organic ink layer is obtained by stylus measurement using a surface roughness measuring device in accordance with JIS B 0601 (1994). Note that, the thickness of the organic ink layer is not the thickness after application of the organic ink composition, which is a precursor of the organic ink layer, but the thickness of the organic ink layer after the organic ink composition is cured.

Note that, the surface of the ceramic color layer has unevenness, and a large amount of the organic ink composition permeates the recessed portions, and as a result, an organic ink layer having a smooth surface is formed. However, a height difference between the unevenness of the ceramic color layer is negligibly small compared to the thickness of the organic ink layer. Therefore, the thickness of the organic ink layer formed in the recessed portions of the ceramic color layer and the thickness of the organic ink layer formed in the protruded portions of the ceramic color layer can be considered to be the same.

The thickness of the organic ink layer does not need to be constant, and it is preferable that the thickness of the organic ink layer at a position 2 mm away from the boundary portion between the glass plate and the ceramic color layer in a direction in which only the organic ink layer is formed be within the above range.

When the organic ink layer is formed at the boundary portion between the ceramic color layer and the glass plate, the thickness of organic ink layer at the boundary portion is preferably smaller than that of the organic ink layer at another region.

The organic ink layer may be formed to have 100% halftone dots, that is, to cover the first main surface of the glass plate or the ceramic color layer without any gaps, which is called solid coating, or may have more than 0% and less than 100% halftone dots. The halftone dots can blur the boundary portion between the glass plate and the organic ink layer and the boundary portion between the organic ink layer and the ceramic color layer on an organic ink and the first main surface of the glass plate. This is effective when the appearance of the boundary portion cannot be said to be good due to a color difference between the glass plate and the organic ink layer or a color difference between the organic ink layer and the ceramic color layer.

The shape of the halftone dots can be any shape, such as a circle, an ellipse, a square, a rhombus, a diamond shape, a pincushion shape, a hexagon, or a T-shape.

When the organic ink layer is also provided in the information transmission and reception region, the information transmission and reception region may be an independent region separated by the organic ink layer 3, as shown in FIG. 8. In addition, the information transmission and reception region may be continuous with another region on the glass plate 1 without being separated by the organic ink layer 3, as shown in FIG. 9.

The organic ink layer is formed by a polymeric resin composition containing a pigment as a coloring agent. The polymeric resin composition contains a resin, a dispersant, a solvent, or the like, as necessary, in addition to the pigment. Note that, this polymeric resin composition is referred to as an “organic ink composition” in the present description.

The pigment may be any coloring material such as an organic pigment, an organic dye, or an inorganic pigment, and can be used alone or in combination of two or more types thereof. The coloring material can be appropriately selected depending on the desired color, and for example, when light-shielding properties are required, a black coloring material or the like is preferably used.

When the organic ink layer is a black layer, the pigment is preferably at least one pigment or dye selected from the group consisting of carbon black, graphite, and a metal oxide, and more preferably carbon black.

When the organic ink layer is a black layer, the color can be represented by a brightness index L* value in a CIE 1976 (L*a*b*) color space (CIELAB) standardized by the International Commission on Illumination (CIE). The brightness index L* value is an index indicating a brightness of a color tone, and can be measured in accordance with JIS Z 8722 (2009). When the L* value is large, the color tone is bright, and when the brightness index L* value is small, the color tone is dark.

When the L* value of the organic ink layer is in the range of 0 to 30, the organic ink layer is black, and the object as the window glass for a vehicle is achieved. The L* value of the organic ink layer is preferably 18 to 30, more preferably 20 to 25, and still more preferably 21 to 23. Here, from the viewpoint of enhancing aesthetic satisfaction with a high quality feeling, the L* value of the organic ink layer is preferably 18 or more, more preferably 20 or more, and still more preferably 21 or more in consideration of a black color degree. On the other hand, when the L* value of the organic ink layer is more than 30, a white color degree increases. Therefore, the L* value is preferably 30 or less, more preferably 25 or less, and still more preferably 23 or less.

The resin may be a resin having any property such as a thermoplastic resin, a photocurable resin, or a thermosetting resin, and preferably a thermosetting resin or a photocurable resin.

Specific examples thereof include known resins such as a polyurethane resin, a phenol-based resin, an epoxy-based resin, a urea melamine-based resin, a silicone-based resin, a phenoxy resin, a methacrylic resin, an acrylic resin, a polyarylate resin, a polyester-based resin, a polyolefin-based resin, a polystyrene-based resin, polyvinyl chloride, a vinyl chloride-vinyl acetate copolymer, polyvinyl acetate, polyvinylidene chloride, a polycarbonate, polyethylene terephthalate, polyether sulfone, an acrylonitrile-butadiene-styrene (ABS) resin, a transparent ABS resin, celluloses, and polyacetal.

The resin may be a resin made of a homopolymer, or a resin made of a copolymer of a monomer copolymerizable with a monomer of these resins. The binder may be used alone or in combination of two or more types thereof.

It is preferable that the photocurable resin have the property of being cured by irradiation with UV light, from the viewpoint of simplifying a resin curing process and eliminating a need for a firing furnace. The photocurable resin can be obtained by adding a photopolymerization initiator to, for example, an acrylic resin among the resins shown above, and a photocured film can be obtained by irradiating this with light.

A thermal curing temperature for the thermosetting resin is preferably 100° C. to 500° C., more preferably 150° C. to 400° C., and still more preferably 200° C. to 300° C. Here, it is preferable to cure the thermosetting resin at a temperature lower than a firing temperature for forming the ceramic color layer, that is, at a temperature lower than the firing temperature that is equal to or higher than the annealing point of the glass plate, from the viewpoint of maintaining a molded shape of the glass plate. Specifically, the thermal curing temperature for the resin is preferably 500° C. or lower, more preferably 400° C. or lower, and still more preferably 300° C. or lower. In addition, from the viewpoint of curing stability of the resin and adhesion to the glass plate, the thermal curing temperature for the resin is preferably 100° C. or higher, more preferably 150° C. or higher, and still more preferably 200° C. or higher.

Examples of such a thermosetting resin include an acrylic resin and a silicone-based resin among the resins shown above.

The dispersant is not particularly limited, and examples thereof include a cellulose derivative, an organic acid, and a terpene compound. Examples of the organic acid include an unsaturated carboxylic acid polymer, and other organic acids may also be used. The dispersant may be used alone or in combination of two or more types thereof.

The solvent is not particularly limited, and examples thereof include known solvents such as water, alcohols, esters, ketones, aromatic hydrocarbon-based solvents, and aliphatic hydrocarbon-based solvents.

As the alcohols, for example, isopropyl alcohol, methanol, or ethanol can be used. As the esters, for example, ethyl acetate can be used. As the ketones, for example, methyl ethyl ketone can be used. As the aromatic hydrocarbon-based solvent, for example, toluene, xylene, Solvesso (trademark) 100, and Solvesso (trademark) 150 can be used. As the aliphatic hydrocarbon-based solvent, for example, hexane can be used.

The solvent may be used alone or in combination of two or more types thereof.

### (Ceramic Color Layer)

The ceramic color layer is provided at least in the periphery on the first main surface of the glass plate. The ceramic color layer may be provided in a region other than the above periphery. The region other than the periphery may be provided, for example, in a peripheral portion of the information transmission and reception region through which a signal transmitted and received by an on-vehicle information communication device, such as a camera and a radar, passes.

The ceramic color layer can be a fired layer by applying a pasty ceramic color composition, which is a precursor of the ceramic color layer, to a desired region on the first main surface of the glass plate and by baking through a heat treatment. Note that, in the present description, the ceramic color layer is a fired body of a ceramic color composition, and the ceramic color composition is an inorganic component containing a glass frit and a pigment. When the ceramic color composition is applied to the first main surface of the glass plate, a mixture with an organic component for forming a paste is referred to as a pasty ceramic color composition.

When the ceramic color composition is fired to form a ceramic color layer, the ceramic color layer is bonded to the glass plate. As a result, even when a conductive layer, a solder layer, or the like is further formed on the surface of the ceramic color layer, peeling of the ceramic color layer from the glass plate is prevented.

The thickness of the ceramic color layer is larger than that of the organic ink layer. The thickness of the ceramic color layer influences an ultraviolet transmittance, acid resistance, weather resistance, glass strength, and cost.

The thickness of the ceramic color layer is preferably 6 μm to 30 μm, more preferably 6 μm to 20 μm, and still more preferably 10 μm or more and less than 15 μm.

Here, when the thickness of the ceramic color layer is too small, for example, when acid rain penetrates the ceramic color layer, the ceramic color layer is discolored or is transparent, and thereby the ceramic color layer may not serve as the original ceramic color layer. Therefore, the thickness of the ceramic color layer is preferably 6 μm or more, and more preferably 10 μm or more.

On the other hand, when the thickness of the ceramic color layer is too large, the ceramic color layer is easily influenced by a stress, which leads to an increase in cost. Therefore, the thickness of the ceramic color layer is preferably 30 μm or less, more preferably 20 μm or less, and still more preferably less than 15 μm.

Similar to the organic ink layer, the thickness of the ceramic color layer is obtained by stylus measurement using a surface roughness measuring device in accordance with JIS B 0601 (1994). The thickness of the ceramic color layer does not need to be constant, and it is preferable that, in a region away from the boundary portion between the glass plate and the ceramic color layer by 1.5 mm or more in a direction in which the ceramic color layer is formed, an average thickness of the ceramic color layer at a given width of 1.0 mm be within the above range.

The surface roughness Ra of the ceramic color layer is preferably 0.25 μm to 2.0 μm, more preferably 0.3 μm to 2.0 μm, and still more preferably 0.35 μm to 1.0 μm. Here, from the viewpoint of adhesiveness of the organic ink layer, the above surface roughness Ra is preferably 0.25 μm or more, more preferably 0.3 μm or more, and still more preferably 0.35 μm or more.

The upper limit of the surface roughness Ra is not particularly limited, and is, for example, preferably 2.0 μm or less, and more preferably 1.0 μm or less, from the viewpoint of the strength of the window glass for a vehicle.

In addition, the value of the surface roughness Ra of the ceramic color layer can be adjusted based on, for example, a crystallinity X and a particle diameter of the ceramic color layer.

The adhesiveness of the organic ink layer can be evaluated by an abrasion test. Specifically, a Taber abrasion test based on JIS R 3212:1998 is performed on a sample in which a ceramic color layer and an organic ink layer are sequentially provided on a first main surface of a glass plate. The surface on which the ceramic color layer and the organic ink layer are formed is polished with an abrasion wheel, and the adhesiveness of the organic ink layer can be evaluated based on a degree to which the organic ink layer remains on the ceramic color layer. For the Taber abrasion test, for example, a rotary abrasion tester TS-2 manufactured by Toyo Seiki Seisaku-sho, Ltd. can be used.

The surface roughness Ra of the ceramic color layer is obtained by stylus measurement using a surface roughness measuring device in accordance with JIS B 0601 (1994).

Qualitatively, by cross-sectional observation using a scanning electron microscope (SEM), it can be confirmed that the surface of the ceramic color layer is uneven compared to the surface of the ceramic color layer covered with the organic ink layer. Similarly, by a cross-sectional profile using a white interference microscopy, it can also be confirmed that the surface of the ceramic color layer is uneven compared to the surface of the ceramic color layer covered with the organic ink layer.

As the pigment in the ceramic color layer, a known pigment can be used. For example, a combination of CuO·Cr₂O₃ (black), CoO·Cr₂O₃ (black), Fe₂O₃ (brown), TiO₂ (white), CoO·Al₂O₃ (blue), NiO·Cr₂O₃ (green) and the like can be used. When such a pigment is used, a desired color, gloss, and opacity, that is, the transmittance characteristics can be imparted. Among them, from the viewpoint of providing the ceramic color layer, it is preferable that the ceramic color layer be a black ceramic layer containing a black pigment.

The pigment in the case of the black ceramic layer is preferably an oxide pigment containing at least one selected from the group consisting of Cu, Fe, Co, Ni, Cr, Si, Mn, Al, and Zn, more preferably a composite oxide pigment containing two or more of these pigments, and still more preferably at least one composite oxide pigment selected from the group consisting of Cu(Cr, Mn)₂O₄, CuCrO₄, Cr₂O₃:Fe₂O₃, Cr₂O₃:Fe₂O₃:CoO, (Fe, Mn)(Mn, Fe)₂O₄, (Co, Fe)(Fe, Cr)₂O₄, (Co, Fe, Mn)(Fe, Cr, Mn)₂O₄, (Co, Fe)(Ni, Cr)₂O₄, and (Cu, Fe, Mn)(Fe, Mn, Al)₂O₄.

Similar to the organic ink layer, when the brightness index L* value in the CIE 1976 (L*a*b*) color space (CIELAB) standardized by the International Commission on Illumination (CIE) is in the range of 0 to 30, the ceramic color layer is a black ceramic layer and the object as the window glass for a vehicle is achieved. The L* value of the ceramic color layer is preferably 18 to 30, more preferably 20 to 25, and still more preferably 21 to 23. Here, from the viewpoint of enhancing aesthetic satisfaction with a high quality feeling, the L* value of the ceramic color layer is preferably 18 or more, more preferably 20 or more, and still more preferably 21 or more in consideration of a black color degree. On the other hand, when the L* value of the ceramic color layer is more than 30, a white color degree increases. Therefore, the L* value is preferably 30 or less, more preferably 25 or less, and still more preferably 23 or less.

It is preferable that the ceramic color composition, which is a precursor of the ceramic color layer, further contain a filler, in addition to the glass frit and the pigment.

Examples of the filler include a crystallization accelerator and what is called a low expansion filler.

The crystallization accelerator is preferably added when it is desired to increase a crystallized region on the ceramic color layer. When firing the ceramic color composition, the crystallized region is formed by a heat treatment at a temperature higher than a crystallization temperature of the glass frit. When a crystallization accelerator is contained in the ceramic color composition, the crystallization accelerator serves as a crystal nucleus, so that crystallization starts at a temperature lower than the above crystallization temperature and the crystallized region increases.

The type of the crystallization accelerator varies depending on the composition of the glass frit. For example, when the glass frit contains Bi, a bismuth silicate-based crystallization accelerator is preferred. In addition, when crystal phases have a similar pattern, the crystallization may be promoted even when the compositions are different.

It is preferable to add a low expansion filler from the viewpoint of improving the strength of the window glass for a vehicle.

For example, when a solder layer is provided on the window glass for a vehicle, a stress due to a difference in thermal expansion coefficient between the glass plate and the solder may be generated in addition to a thermal stress due to local heating of the glass plate during soldering and a residual stress after cooling, thereby decreasing the strength of the window glass for a vehicle. In contrast, when a low expansion filler is contained in the ceramic color layer interposed between the glass plate and the solder layer, expansion of the ceramic color layer due to local heating of the glass plate during soldering can be prevented. Accordingly, the stress due to the difference in thermal expansion coefficient between the glass plate and the solder can be reduced, and a decrease in strength of the window glass for a vehicle can be prevented.

As the low expansion filler, a known low expansion filler can be used. Examples of the low expansion filler include cordierite, zircon, alumina, titania, zirconium phosphate, silica, and forsterite. One of these may be used, or two or more types thereof may be used in combination. Among these, it is more preferable to contain at least one selected from the group consisting of cordierite, zircon, and silica.

The ceramic color layer may further contain an oxidizing agent as long as the effect of the present invention is not impaired. As the oxidizing agent, a known oxidizing agent can be used, and examples thereof include CeO₂ and MnO₂.

The thermal expansion coefficient of the ceramic color layer is preferably close to the thermal expansion coefficient of the glass plate from the viewpoint of obtaining a high strength as the window glass for a vehicle. When the thermal expansion coefficient of the ceramic color layer is brought close to the thermal expansion coefficient of the glass plate, even in the case where a residual stress is generated on the glass plate when providing a lead-free solder layer on a conductive film containing silver that is separately printed on the window glass for a vehicle, expansion of the ceramic color layer can be prevented, and a decrease in strength of the window glass for a vehicle can be prevented. In addition, when the thermal expansion coefficients of the ceramic color layer and the glass plate are brought close to each other, in forming the ceramic color layer at a temperature equal to or higher than an annealing point of the glass, it is possible to prevent the occurrence of the distortion in the glass plate at the boundary between the region where the ceramic color layer is formed and the region where the ceramic color layer is not formed. This distortion in the glass plate is caused by preventing the occurrence of the uneven shape on the glass plate at the boundary between the region where the ceramic color layer is formed and the region where the ceramic color layer is not formed, due to the difference in thermal expansion coefficient between the ceramic color layer and the glass plate.

The thermal expansion coefficient of the ceramic color layer is preferably equal to or smaller than the thermal expansion coefficient of the glass plate. For example, when a soda lime glass is used as the glass plate, the thermal expansion coefficient thereof is 85×10⁻⁷/° C. to 90×10⁻⁷/° C. Therefore, the thermal expansion coefficient of the ceramic color layer at 50° C. to 350° C. is, for example, preferably 40×10⁻⁷/° C. to 85×10⁻⁷/° C., more preferably 50×10⁻⁷/° C. to 80×10⁻⁷/° C., and still more preferably 60×10⁻⁷/° C. to 77×10⁻⁷/° C. Here, the thermal expansion coefficient of the ceramic color layer at 50° C. to 350° C. is preferably 40×10⁻⁷/° C. or more, more preferably 50×10⁻⁷/° C. or more, still more preferably 60×10⁻⁷/° C. or more, and is preferably 85×10⁻⁷/° C. or less, more preferably 80×10⁻⁷/° C. or less, still more preferably 77×10⁻⁷/° C. or less. Note that, since it is difficult to directly measure the thermal expansion coefficient of the ceramic color layer, the thermal expansion coefficient is a value measured using a differential thermal dilatometer based on an average value of percentages of elongation per 1ºC at the time of heating the ceramic color composition in the range of 50° C. to 350° C.

The distortion that occurs in the glass plate when there is a difference in thermal expansion coefficient between the ceramic color layer and the glass plate can be confirmed visually. Alternatively, it can be measured quantitatively using polarized light, and based on this measurement, the residual stress applied to the glass plate can be calculated. Specifically, a magnitude of birefringence is measured, and the residual stress is calculated using a separately obtained photoelastic constant of the glass plate. A device for measuring the birefringence is commercially available from Luceo Co., Ltd, Orihara industrial co., ltd, HINDS Instruments in U.S.A., or the like, and a crossed Nicols method, a circular polarization method, a sensitive tint method, a Senarmont method, a rotating analyzer method, or the like is adopted. However, these devices can only measure the stress in a transparent glass plate portion, and cannot measure the stress in the ceramic color layer. Therefore, it is necessary to consider by estimating that a stress balanced with the stress of the glass plate remains for the ceramic color layer.

### (Glass Plate)

The glass plate has a first main surface and a second main surface. Further, the glass plate may have a curved surface shape in which the first main surface is concave.

Although the ceramic color layer and the organic ink layer are provided at least in the periphery on the first main surface, this does not in any way exclude that the ceramic color layer and the organic ink layer are provided in other regions.

For example, the glass plate may have an information transmission and reception region through which a signal transmitted and received by the information communication device disposed on the first main surface side passed, and the ceramic color layer or the organic ink layer may be provided to form such an information transmission and reception region.

In addition, the glass plate may have an outer edge region directly provided with the organic ink layer, between the outer peripheral end of the first main surface of the glass plate and the outer peripheral end of the ceramic color layer provided in the periphery on the first main surface.

It is preferable that the glass plate be disposed in a vehicle such that the first main surface is on a vehicle inner side and the second main surface is on a vehicle outer side.

Accordingly, at least a part of light in the infrared region in the sunlight entering the vehicle from outside the vehicle is absorbed by the ceramic color layer, and it is possible to prevent deterioration due to discoloration of the organic ink layer located at the vehicle inner side with respect to the ceramic color layer.

As the glass plate, a known glass plate used for the window glass for a vehicle in the related art can be used. Examples thereof include a soda lime glass, an aluminosilicate glass, a borosilicate glass, an alkali-free glass, and a quartz glass.

As the glass plate, a glass plate subjected to a strengthening treatment as necessary can be used. Particularly, when the window glass for a vehicle is a window glass for an automobile and is used as a side glass or a rear glass, a strengthening treatment may be performed according to a required safety standard.

The strengthening treatment may be a chemical strengthening treatment or a physical strengthening treatment (air cooling strengthening treatment), and the physical strengthening treatment is preferred from the viewpoint of a strengthening treatment time and cost.

The physical strengthening treatment is a treatment method that strengthens the surface of the glass plate by generating a compressive stress layer on the surface of the glass plate due to a temperature difference between the surface and the inside of the glass plate. Specifically, the compressive stress layer due to a temperature difference is generated by an operation other than annealing, such as rapid cooling by spraying a cooling medium onto the glass plate heated to be equal to or higher than the annealing point of the glass, for example, 500° C. to 600° C. or higher.

The chemical strengthening treatment is a treatment in which the glass plate is brought into contact with a metal salt by a method such as immersion of the glass plate in a molten solution of a metal salt containing metal ions having a large ion radius, and metal ions having a small ion radius in the glass are substituted with the metal ions having a large ion radius. Typically, lithium ions are substituted with sodium ions or potassium ions, and sodium ions are substituted with potassium ions.

When the chemical strengthening treatment is performed, a known molten solution of a metal salt, that is, a molten salt can be used. Conditions in the chemical strengthening treatment are appropriately selected in consideration of the glass composition, the type of the molten salt, and the like. In addition, the chemical strengthening treatment may be performed in multiple stages, or cleaning with an alkaline solution, cleaning by plasma irradiation, or the like may be performed.

The thickness of the glass plate may be set according to the purpose, and is not particularly limited.

For example, in the case of being used for a window glass for an automobile among vehicles, the thickness of the glass plate is approximately 0.2 mm to 5.0 mm, and preferably 0.3 mm to 3.0 mm. Here, the thickness of the glass plate is approximately 0.2 mm or more, preferably 0.3 mm or more, and is approximately 5.0 mm or less, preferably 3.0 mm or less.

In the case of being used for a window glass for an automobile, particularly for a laminated glass and then for a windshield, the window glass for a vehicle according to the present embodiment may be used so as to be located on the vehicle outer side, or may be used so as to be located on the vehicle inner side, or may be used for both.

In the case of being used as a laminated glass for a windshield and located on the vehicle outer side, the thickness of the glass plate is more preferably 1.1 mm to 3.0 mm, and still more preferably 1.5 mm to 2.8 mm. Here, from the viewpoint of strength such as flying stone resistance, the thickness of the glass plate is more preferably 1.1 mm or more, and still more preferably 1.5 mm or more. In addition, from the viewpoint of weight reduction of the laminated glass, the thickness of the glass plate is preferably 3.0 mm or less, and more preferably 2.8 mm or less.

In the case of being used as a laminated glass for a windshield and located on the vehicle inner side, the thickness of the glass plate is more preferably 0.3 mm to 2.3 mm. Here, the thickness of the glass plate is preferably 0.3 mm or more from the viewpoint of handling properties, and more preferably 2.3 mm or less from the viewpoint of weight reduction.

Note that, it is preferable that both the glass plate located on the vehicle outer side and the glass plate located on the vehicle inner side in the case of being used as a laminated glass for a windshield be an un-strengthened glass that has not been subjected to a strengthening treatment, from the viewpoint of preventing cracks from spreading across the entire surface in the event of damage.

### <Method for Manufacturing Window Glass For a Vehicle>

A method for manufacturing a window glass for a vehicle according to the present embodiment sequentially includes the following step a to step c.

(Step a) a step of preparing a glass plate having a first main surface and a second main surface;

(Step b) a step of applying a pasty ceramic color composition to at least a periphery on the first main surface of the glass plate and performing a heat treatment to form a ceramic color layer; and

(Step c) a step of applying an organic ink composition to cover at least a partial region on the ceramic color layer formed in the periphery, and curing the organic ink composition to form an organic ink layer.

In the step c, the organic ink composition is applied such that a thickness of the organic ink layer is smaller than a thickness of the ceramic color layer.

### (Step a)

As the glass plate having a first main surface and a second main surface, those described in (Glass Plate) in the above <Window Glass For a Vehicle>can be preferably used. The glass plate can be manufactured, or a commercially available glass plate may be used.

A size of the glass plate may be appropriately determined according to the application. For example, when the window glass for a vehicle is a windshield for an automobile, a glass plate of 500 mm to 1,300 mm×1,200 mm to 1,700 mm×1.6 mm to 2.5 mm is prepared.

Generally, one glass plate is used, and in the case of a laminated glass for a vehicle, two or more glass plates may be bonded together to form a laminated glass and then subjected to the subsequent step b. In addition, after manufacturing a window glass for a vehicle using one glass plate, one or more other glass plates may be bonded together to form a laminated glass.

### (Step b)

A pasty ceramic color composition is applied to at least the periphery on the first main surface of the glass plate prepared in the step a. In addition, the pasty ceramic color composition may be applied to other desired regions. For example, the pasty ceramic color composition may be applied to a peripheral portion of an information transmission and reception region through which a signal transmitted and received by an information communication device disposed on a first main surface side passes.

The pasty ceramic color composition is a pasty ceramic color composition containing a glass frit, a pigment, and further various fillers as necessary, and is a precursor of the ceramic color layer. The ceramic color layer is formed by firing this ceramic color composition by a heat treatment. It is preferable that the heat treatment be performed at a firing temperature equal to or higher than the annealing point of the glass plate, and that the glass plate be bent and molded at the same time as the formation of the ceramic color layer. On the other hand, when the heat treatment is performed at a firing temperature equal to or higher than the annealing point of the glass plate, a distortion occurs in the glass plate near the boundary portion between the ceramic color layer and the glass plate.

As each component such as the glass frit and the pigment in the ceramic color composition, those described in (Ceramic Color Layer) in the above <Window Glass For a Vehicle>can be preferably used.

In order to obtain various characteristics of the glass frit in the ceramic color composition, one type of the glass frit may be used, or two or more types of glass frits may be used in combination. Further, two or more types of the glass frits having the same composition and different particle diameters may be appropriately mixed and used.

A softening point Ts of the glass frit in the ceramic color composition is also related to the temperature when the glass plate is subjected to firing and bending. The softening point Ts of the glass frit is preferably 500° C. to 580° C., and more preferably 520° C. to 540° C. Here, from the viewpoint of a good baking, the softening point Ts of the glass frit is preferably 500° C. or higher, and more preferably 520° C. or higher. On the other hand, in the case of further forming a conductive layer or the like on the window glass for a vehicle, the softening point Ts of the glass frit is preferably 580° C. or lower, and more preferably 540° C. or lower.

When two or more types of the glass frits are used in combination, it is more preferable that one or more types of the glass frits have a softening point within the above range, and it is still more preferable that all the glass frits have a softening point within the above range.

The softening point Ts of the glass frit can be controlled based on the composition of the glass frit. Note that, the softening point Ts in the present description is a temperature corresponding to a fourth inflection point in a DTA chart obtained by differential thermal analysis (DTA) of the glass frit. Note that, although it is difficult to directly measure the softening point Ts of the glass frit from the window glass for a vehicle after firing, the composition of the glass frit can be estimated based on the composition or the like of the ceramic color layer, and the softening point Ts can be estimated based on regression calculation using the composition of the glass frit.

A particle diameter D₅₀ of the glass frit is preferably 0.1 μm to 3.0 μm, more preferably 0.3 μm to 2.5 μm, and still more preferably 0.5 μm to 2.0 μm. Here, when the glass frit is too atomized, the specific surface area is increased, and moisture and carbon dioxide gas in the atmosphere are easily adsorbed. Then, foaming may occur during the formation of the ceramic color layer by firing, which may lead to a decrease in transmittance, strength, or the like. Therefore, the particle diameter D₅₀ of the glass frit is preferably 0.1 μm or more, more preferably 0.3 μm or more, and still more preferably 0.5 μm or more. In addition, in the case of forming other layers such as a conductive layer on the glass plate, the particle diameter D₅₀ of the glass frit is preferably 3.0 μm or less, more preferably 2.5 μm or less, and still more preferably 2.0 μm or less.

The particle diameter D₅₀ of the glass frit is a cumulative median diameter D₅₀ in the volume-based particle size distribution, and is measured by a laser diffraction scattering method.

From the viewpoint of preventing clogging in the case of forming the ceramic color composition on the surface of the glass plate by screen printing, a maximum particle diameter Dₘₐₓ of the glass frit is preferably 30 μm or less, more preferably 20 μm or less, and still more preferably 15 μm or less. In addition, when the ceramic color composition is sintered, coarse particles remain without being melted, which may cause deterioration of sinterability or a decrease in strength. Therefore, the maximum particle diameter Dₘₐₓ of the glass frit is even more preferably 10 μm or less.

A content of the glass frit in the ceramic color composition is preferably 60 mass % to 90 mass %, more preferably 65 mass % to 85 mass %, and still more preferably 70 mass % to 80 mass %. Here, from the viewpoint of obtaining a good sinterability, the content of the glass frit is preferably 60 mass % or more, more preferably 65 mass % or more, and still more preferably 70 mass % or more. On the other hand, from the viewpoint of preventing a decrease in strength of the window glass for a vehicle due to an excessively high thermal expansion coefficient of the ceramic color layer, the content of the glass frit is preferably 90 mass % or less, more preferably 85 mass % or less, and still more preferably 80 mass % or less.

Note that, the content in the ceramic color composition in the present description means a content in a total amount of inorganic components among components constituting the ceramic color composition, and a content of organic components is not taken into account. Therefore, the content of the glass frit in the ceramic color composition is an amount excluding contents of the filler and the pigment contained in the ceramic color composition.

A content of the pigment in the ceramic color composition is preferably 5 mass % to 30 mass %, more preferably 5 mass % to 25 mass %, still more preferably 10 mass % to 20 mass %, and particularly preferably 10 mass % to 15 mass %. Here, from the viewpoint of obtaining a desired color tone, the content of the pigment is preferably 5 mass % or more, and more preferably 10 mass % or more. In addition, from the viewpoint of not inhibiting the sinterability of the ceramic color layer, the content of the pigment is preferably 30 mass % or less, more preferably 25 mass % or less, still more preferably 20 mass % or less, and particularly preferably 15 mass % or less.

A content of the low expansion filler, among the filler, in the ceramic color composition is preferably 3 mass % to 30 mass %, more preferably 5 mass % to 25 mass %, and still more preferably 10 mass % to 20 mass %. Here, from the viewpoint of controlling the thermal expansion coefficient, a good fluidity, maintaining the strength of the glass plate, releasability, and the like, the content of the low expansion filler is preferably 3 mass % or more, more preferably 5 mass % or more, and still more preferably 10 mass % or more. In addition, from the viewpoint of not inhibiting the sinterability of the glass frit, the content of the low expansion filler is preferably 30 mass % or less, more preferably 25 mass % or less, and still more preferably 20 mass % or less.

A thermal expansion coefficient of the ceramic color composition at 50° C. to 350° C. is preferably 50×10⁻⁷/° C. to 130×10⁻⁷/° C., more preferably 55×10⁻⁷/° C. to 100×10⁻⁷/° C., still more preferably 60×10⁻⁷/° C. to 85×10⁻⁷/° C., and even more preferably 60×10⁻⁷/° C. to 77×10⁻⁷/° C. or less. Here, from the viewpoint of favorably maintaining the strength of the glass plate, the thermal expansion coefficient of the ceramic color composition at 50° C. to 350° C. is preferably 50×10⁻⁷/° C. or more, more preferably 55×10⁻⁷/° C. or more, still more preferably 60×10⁻⁷/° C. or more, and is preferably 130×10⁻⁷/° C. or less, more preferably 100×10⁻⁷/° C. or less, still more preferably 85×10⁻⁷/° C. or less, and even more preferably 77×10⁻⁷/° C. or less.

In order to sufficiently decompose an organic vehicle, an oxidizing agent may be added as the filler. However, in consideration of a decrease in the sinterability of the ceramic color layer, a content of the oxidizing agent is preferably 10 mass % or less.

The ceramic color composition is formed into a paste by dispersing the glass frit, the pigment, and the filler as necessary, in the organic vehicle at the above percentages. The organic vehicle is a vehicle containing an organic binder, and is used for forming the ceramic color composition into a paste.

The organic vehicle is obtained by dissolving a polymer compound in a solvent. As the polymer compound and the solvent, known compounds can be used. Examples of the polymer compound include ethyl cellulose, an acrylic resin, a styrene resin, a phenol resin, and a butyral resin. As the solvent, for example, α-terpineol, butyl carbitol, butyl carbitol acetate, 2,2,4-trimethyl-1,3-pentanediol monoisobutyrate, 2,2,4-trimethyl-1,3-pentanediol diisobutyrate, ethylene glycol mono-2-ethylhexyl ether, diethylene glycol mono-2-ethylhexyl ether, ethylene glycol monohexyl ether, diethylene glycol monohexyl ether, ethylene glycol monobutyl ether acetate, and diethylene glycol monobutyl ether, and diethylene glycol monobutyl ether can be used.

A concentration of the polymer compound in the organic vehicle is not particularly limited, and is generally 0.5 mass % to 15 mass %.

In the pasty ceramic color composition, a content of the organic vehicle containing the polymer compound is preferably 2 mass % to 40 mass %, more preferably 5 mass % to 30 mass %, and still more preferably 10 mass % to 25 mass %. Here, in consideration of printability during the screen printing, the content of the organic vehicle is preferably 2 mass % or more, more preferably 5 mass % or more, and still more preferably 10 mass % or more. On the other hand, in consideration of a binder removal property, the content of the organic vehicle is preferably 40 mass % or less, more preferably 30 mass % or less, and still more preferably 25 mass % or less.

The pasty ceramic color composition is applied to the periphery on the first main surface of the glass plate. As necessary, it may be applied to another region such as the peripheral portion of the information transmission and reception region.

The application method is not particularly limited, and a screen printing method, an inkjet method, an electronic printing method, or the like can be used, and the thickness is adjusted such that the ceramic color layer has a desired thickness. For example, a screen printing method using a screen of a #150 mesh to a #400 mesh is preferred.

Next, the applied ceramic color composition is dried as necessary, and a heat treatment is performed for baking onto the glass plate, thereby forming a ceramic color layer. Drying is performed, for example, at room temperature to 200° C. for 5 minutes to 10 minutes.

For the heat treatment, a heating furnace such as an IR furnace is used, for example. At this time, it is preferable to perform the heat treatment at a firing temperature equal to or higher than the annealing point of the glass plate, and accordingly, the glass plate can be bent and molded at the same time as the formation of the ceramic color layer. However, this does not exclude separately firing and bending the glass plate after forming the ceramic color layer.

When the ceramic color layer is formed into a fired layer, the ceramic color layer can be favorably bonded to the glass plate. In addition, from the viewpoint of cost, it is preferable to form the ceramic color layer and bend and mold the glass plate at the same time.

In the case of performing firing and bending at the same time as the firing of the ceramic color layer, the firing temperature is preferably a temperature equal to or higher than the annealing point of the glass plate, and preferably a temperature equal to or lower than (the annealing point of the glass plate +200° C.)

Since the annealing point of a soda lime glass plate generally used in the window glass for a vehicle is 500° C. to 600° C., the firing temperature for forming the ceramic color layer is preferably about 600° C. to 800° C.

In the case of performing bending and molding of the glass plate, it is preferably performed such that the first main surface is concave. Examples of a method for bending the glass plate include press bending molding in which the glass plate is heated to a temperature equal to or higher than the annealing point and then the glass plate is pressed against a mold having a desired shape to be bent, and gravity bending molding in which the glass plate is bent by its own weight.

From the viewpoint of making the surface of the ceramic color layer smooth or from the viewpoint of obtaining a desired shape, press bending molding using a press device such as a heating press device is preferred. In addition, from the viewpoint of preventing an optical distortion, press bending molding is also preferred.

In the gravity bending molding, the glass plate is bent by a self-weight bending device, and unlike the press bending molding, a mold having a desired shape is not required, which is advantageous in terms of cost.

The glass plate may have a single-bent shape that is bent and molded only in one direction, for example, only in a front-rear direction or an up-down direction of an automobile in the case of being attached to an opening of the automobile. In addition, the glass plate may have a multiple-bent shape that is bent and molded in the front-rear direction and the up-down direction. When the glass plate is bent and molded to have a predetermined curvature and is curved, a curvature radius of the glass plate is, for example, 1,000 mm to 100,000 mm.

An overall structure (composition) of the obtained ceramic color layer can be directly analyzed by X-ray fluorescence, SEM-energy dispersive X-ray analysis (EDX), EPMA (electron probe microanalyzer), SIMS (secondary ion mass spectrometry), X-ray photoelectron spectroscopy (XPS), or the like on the surface or the cross section. In addition, all elements can be measured by cutting only the ceramic color layer with a micromanipulator and using ICP-AES (ICP emission spectrometry) or ICP-MS (inductively coupled plasma mass spectrometry).

Crystalline pigments and fillers are determined by quantitative analysis using respective standard samples by SEM-EDX or XRD, and a residue is calculated as the amount of the glass frit. Accordingly, ratios of the glass frit, the pigment, and the filler in the ceramic color layer are obtained.

The particle diameter and the particle size distribution of the filler in the ceramic color layer is obtained from a frequency distribution graph by observing a filler component with a cross section SEM-EDX and performing image analysis on the filler composition with WinROOF manufactured by MITANI CORPORATION.

In addition, the glass composition is obtained by the above combination, and thermal properties such as an annealing point may also be calculated by regression calculation of the obtained glass composition.

### (Step c)

An organic ink layer is applied to cover at least a partial region on the ceramic color layer in the periphery, which is formed in the step b, and is cured to form an organic ink layer. The organic ink composition is applied such that a thickness of the organic ink layer is smaller than a thickness of the ceramic color layer.

When a heat treatment is performed at a firing temperature equal to or higher than the annealing point of the glass plate in the step b, a distortion occurs in the glass plate near the ceramic color layer due to a difference in thermal expansion coefficient between the glass plate and the ceramic color layer. Further, even when the glass plate is bent and molded after the formation of the ceramic color layer, a distortion occurs in the glass plate as well.

In this way, when a distortion occurs in the glass plate near the ceramic color layer, it is preferable that the organic ink layer be formed to also cover a portion of the glass plate where the distortion occurs, that is, a partial region on the first main surface of the glass plate, as well as the boundary portion between the glass plate and the ceramic color layer.

In addition, when the region on the glass plate where the distortion occurs is located in or near the information transmission and reception region through which a signal transmitted and received by an on-vehicle information communication device passes, the signal transmitted and received by the information communication device may not be transmitted accurately. Therefore, it is also preferable to form the organic ink layer to cover a partial region on the first main surface of the glass plate, as well as the boundary portion between the glass plate and the ceramic color layer, so as to form the information transmission and reception region.

Further, when it is desired to provide a colored opaque layer also in the outer edge region between the outer peripheral end of the first main surface of the glass plate and the outer peripheral end of the ceramic color layer from the viewpoint of design, it is also preferable to form the organic ink layer in the outer edge region.

As each component in the organic ink composition, those described in (Organic Ink Layer) in the above <Window Glass For a Vehicle>can be preferably used.

A content of the coloring material in the organic ink composition is preferably 0.1 mass % to 20 mass %, and more preferably 1 mass % to 10 mass %. Here, from the viewpoint of obtaining the light-shielding properties, the content of the coloring material is preferably 0.1 mass % or more, and more preferably 1 mass % or more. In addition, from the viewpoint of ink aggregation, the content of the coloring material is preferably 20 mass % or less, and more preferably 10 mass % or less.

A content of the resin in the organic ink composition is preferably 1 mass % to 50 mass %, and more preferably 10 mass % to 30 mass %. Here, the content of the resin is preferably 1 mass % or more, and more preferably 10 mass % or more. In addition, the content of the resin is preferably 50 mass % or less, and more preferably 30 mass % or less.

A content of the solvent in the organic ink composition is preferably 20 mass % to 80 mass %, and more preferably 40 mass % to 60 mass %. Here, the content of the solvent is preferably 20 mass % or more, and more preferably 40 mass % or more. In addition, the content of the solvent is preferably 80 mass % or less, and more preferably 60 mass % or less.

The method of applying the organic ink composition is not particularly limited, and examples thereof include a gravure printing method, a flexographic printing method, an offset printing method, a letterpress printing method, a screen printing method, a pad printing method, a spray printing method, and an inkjet printing method. Among them, an inkjet printing method is preferred since it is printing after the glass plate is molded, can be easily applied to various shapes, and does not require a gravure. Note that, the glass plate may be preheated before applying the organic ink composition to the glass plate.

The organic ink composition is applied such that the thickness of the organic ink layer is smaller than the thickness of the ceramic color layer after curing. The application thickness of the organic ink composition varies depending on the composition such as the content of the coloring material, and is generally 1 μm to 10 μm.

Curing of the organic ink composition is preferably thermal curing or photocuring, and is determined according to the type of the resin constituting the organic ink composition.

In the case of forming the organic ink layer by thermal curing, a heat treatment temperature in the thermal curing is preferably 100° C. to 500° C., more preferably 150° C. to 400° C., and still more preferably 200° C. to 300° C. Here, it is preferable to perform curing at a temperature lower than a firing temperature for forming the ceramic color layer, that is, at a temperature lower than the firing temperature that is equal to or higher than the annealing point of the glass plate, from the viewpoint of maintaining a molded shape of the glass plate. Specifically, the heat treatment temperature in the thermal curing is preferably 500° C. or lower, more preferably 400° C. or lower, and still more preferably 300° C. or lower. In addition, from the viewpoint of curing stability of the resin and adhesion to the glass, the heat treatment temperature in the thermal curing is preferably 100° C. or higher, more preferably 150° C. or higher, and still more preferably 200° C. or higher.

In addition to the above, the window glass for a vehicle according to the present embodiment may further include a conductive layer, a solder layer, a low reflection film layer, a heat insulating film layer, a UV cutting film layer, or the like, if desired. In this case, respective known layers can be formed using known methods.

The window glass for a vehicle and the manufacturing method therefor according to the present embodiment have been described in detail above, and other aspects of the present embodiment are as follows. That is, the present invention relates to the following [1]′ to [15]′.

[1]′ A window glass for a vehicle including:
a glass plate having a first main surface and a second main surface;
a ceramic color layer; and
an organic ink layer, in which
the ceramic color layer is provided at least in a periphery on the first main surface of the glass plate,
the organic ink layer is provided to cover at least a partial region on the ceramic color layer provided in the periphery, and
a thickness of the organic ink layer is smaller than a thickness of the ceramic color layer.

[2]′ The window glass for a vehicle according to the above [1]′, in which the ceramic color layer has a surface roughness Ra of 0.25 μm or more.

[3]′ The window glass for a vehicle according to the above [1]′ or [2]′, in which the glass plate has a curved surface shape in which the first main surface is concave, and the organic ink layer is provided to further cover a partial region on the first main surface of the glass plate, as well as a boundary portion between the glass plate and the ceramic color layer provided in the periphery.

[4]′ The window glass for a vehicle according to any one of the above [1]′ to [3]′, in which an outer edge region where the ceramic color layer is not formed is present between an outer peripheral end of the first main surface of the glass plate and an outer peripheral end of the ceramic color layer provided in the periphery, and the organic ink layer is provided in the outer edge region.

[5]′ The window glass for a vehicle according to any one of the above [1]′ to [4]′, in which the thickness of the ceramic color layer is 6 μm to 30 μm, and the thickness of the organic ink layer is 1 μm to 10 μm.

[6]′ The window glass for a vehicle according to any one of the above [1]′ to [5]′, in which the window glass is configured to be disposed in a vehicle such that the first main surface of the glass plate is on a vehicle inner side and the second main surface of the glass plate is on a vehicle outer side.

[7]′ A laminated glass for a vehicle including: the window glass for a vehicle according to any one of the above [1]′ to [6]′.

[8]′ A windshield for a vehicle including: the window glass for a vehicle according to any one of the above [1]′ to [6]′, or the laminated glass for a vehicle according to the above [7]′.

[9]′ A method for manufacturing a window glass for a vehicle, sequentially including: preparing a glass plate having a first main surface and a second main surface; applying a pasty ceramic color composition to at least a periphery on the first main surface of the glass plate and performing a heat treatment to form a ceramic color layer; and applying an organic ink composition to cover at least a partial region on the ceramic color layer provided in the periphery, and curing the organic ink composition to form an organic ink layer.

[10]′ The method for manufacturing a window glass for a vehicle according to the above [9]′, in which the heat treatment is performed at a firing temperature equal to or higher than an annealing point of the glass plate while the glass plate is also bent and molded.

[11]′ The method for manufacturing a window glass for a vehicle according to the above [9]′ or [10]′, in which the organic ink layer is formed to also cover a partial region on the first main surface of the glass plate, as well as a boundary portion between the glass plate and the ceramic color layer provided in the periphery.

[12]′ The method for manufacturing a window glass for a vehicle according to any one of the above [9]′ to [11]′, in which the organic ink composition is applied by an inkjet printing.

[13]′ The method for manufacturing a window glass for a vehicle according to any one of the above [9]′ to [12]′, in which the ceramic color layer is formed such that an outer edge region where the ceramic color layer is not formed is present between an outer peripheral end of the first main surface of the glass plate and an outer peripheral end of the ceramic color layer, and the organic ink layer is formed in the outer edge region.

[14]′ The method for manufacturing a window glass for a vehicle according to any one of the above [9]′ to [13]′, in which the organic ink layer is formed by thermal curing or photocuring of the organic ink composition.

[15]′ The method for manufacturing a window glass for a vehicle according to any one of the above [9]′ to [14]′, in which the organic ink layer is formed by thermal curing of the organic ink composition, and the thermal curing is performed at a heat treatment temperature lower than the firing temperature equal to or higher than the annealing point of the glass plate.

### EXAMPLES

Hereinafter, the present invention will be specifically described with reference to test examples, but the present invention is not limited thereto. Example 1 and Example 2 are reference inventive examples, and Example 3 to Example 5 are reference comparative examples. Note that, the glass plates in these test examples are each a flat plate of 100 mm×100 mm×3.5 mm. However, it can be assumed that the test is carried out by cutting out the ceramic color layer and the organic ink layer, and a region where the ceramic color layer or the organic ink layer is formed, including the periphery, from the glass plate that constitutes the window glass for a vehicle. Therefore, it may be considered that the same results as inventive examples and comparative examples can be obtained in the case where a glass plate having a certain size is used as a window glass for a vehicle.

### Example 1

One main surface of a soda lime silica glass plate of 100 mm×100 mm×3.5 mm was defined as a first main surface, and screen printing was performed using a pasty ceramic color composition A (for a laminated glass (gravity bending molding), manufactured by Ferro Japan Co., Ltd) at a size of 90 mm×90 mm on the first main surface, followed by drying at 120° C. Thereafter, the glass plate formed with a layer of the ceramic color composition was subjected to a heat treatment at 600° C. for 6 minutes and 40 seconds, and cooled to ordinary temperature to form a black ceramic color layer A as a fired layer.

Next, an inkjet printing was performed using an organic ink composition so as to have a size of 90 mm×90 mm and to deviate the center thereof by 4 mm×4 mm from the center of the ceramic color layer A, followed by drying at 130° C. for 10 minutes. At this time, a layer of the organic ink composition covers a region of 86 mm×86 mm in the ceramic color layer A. Thereafter, the glass plate formed with the layer of the organic ink composition was subjected to a heat treatment at 200° C. for 60 minutes to thermally cure the organic ink composition, and then cooled to ordinary temperature to form an organic ink layer. Accordingly, a small piece of a window glass for a vehicle in which the ceramic color layer A and the organic ink layer were formed on or above the first main surface of the glass plate was obtained.

The annealing point of the soda lime silica glass plate used is 550° C.

Table 1 shows the contents of the pigment, the glass frit, and the organic component in the pasty ceramic color composition A. Table 1 also shows the total content of Bi and Si, which are main components, among the contents of the glass frit. The total content of Bi and Si, which are main components, is the content in the pasty ceramic color composition.

As the organic ink composition, Photoblack (registered trademark) manufactured by TORAY INDUSTRIES, INC. was used.

### Example 2

A small piece of a window glass for a vehicle in Example 2 was obtained in the same manner as in Example 1, except that instead of the pasty ceramic color composition A, a pasty ceramic color composition B (for a laminated glass (press bending molding), manufactured by Ferro Japan Co., Ltd) listed in Table 1 was used to form a ceramic color layer B, the thickness thereof was changed to the thickness listed in Table 2, and the thickness of the organic ink layer was also changed to the thickness listed in Table 2.

### Example 3

The ceramic color layer A was formed on the glass plate in the same manner as in Example 1, except that the thickness of the ceramic color layer was changed to the thickness listed in Table 2. Then, a small piece of a window glass for a vehicle in Example 3 was obtained without forming the organic ink layer.

### Example 4

The ceramic color layer B was formed on the glass plate in the same manner as in Example 2, except that the thickness of the ceramic color layer was changed to the thickness listed in Table 2. Then, a small piece of a window glass for a vehicle in Example 4 was obtained without forming the organic ink layer.

### Example 5

A small piece of a window glass for a vehicle in Example 5 was obtained in the same manner as in Example 1, except that the organic ink layer was formed directly on the glass plate without forming the ceramic color layer, and the thickness thereof was also changed.

TABLE 1
(mass %)

| Pasty ceramic color composition | A | B |
|---|---|---|
| Pigment | 22 | 15 |
| Glass frit | 58 | 62 |
| (Main components (Bi + Si)) | (35) | (29) |
| Organic component | 20 | 23 |

### (Evaluation: Surface Property)

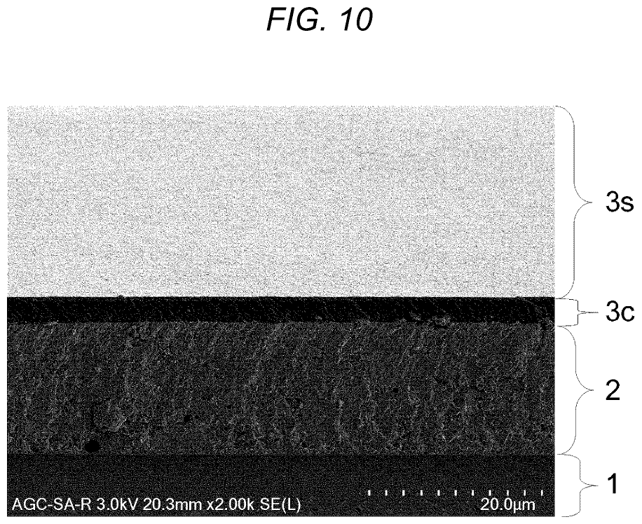

A cross section of the small piece of the window glass for a vehicle was observed using a field emission scanning electron microscope (FE-SEM, Regulus 8220, manufactured by Hitachi High-Tech Corporation). FE-SEM photographs of Examples 1 to 4 are shown in FIG. 10 to FIG. 13, respectively.

### (Evaluation: Thickness and Surface Roughness)

The small piece of the window glass for a vehicle was subjected to stylus measurement using a surface roughness measuring device (ACCRETECH, SURFCOM NEX 001 DX-12, manufactured by TOKYO SEIMITSU CO., LTD) in accordance with JIS B 0601 (1994), and cross-sectional shapes of the ceramic color layer and the organic ink layer were observed. The thickness of the ceramic color layer, the thickness of the organic ink layer, the surface roughness Ra of the ceramic color layer formed on the glass plate and not covered with the organic ink layer, the surface roughness Ra of the organic ink layer formed directly on the glass plate, and the surface roughness Ra of the organic ink layer formed on the ceramic color layer are shown in Table 2.

### (Evaluation: Static Load Strength)

The obtained small piece of the window glass for a vehicle was placed on a ring having a diameter of 98 mm such that the first main surface of the glass plate faced downward, and a ring having a diameter of 46 mm was placed thereon. Then, a load was applied at a rate of 1 mm/min using a static load device (Autograph AGS-X, manufactured by Shimadzu Corporation), and the load at which the small piece of the window glass for a vehicle was broken was measured. Such a test was performed at least seven times, and the average value was taken as the static load strength. The results are shown in Table 2.

TABLE 2

| | Example 1 | Example 2 | Example 3 | Example 4 | Example 5 |
|---|---|---|---|---|---|
| Ceramic color layer | A | B | A | B | — |
| Thickness (μm) of ceramic | 14.98 | 12.13 | 18.30 | 13.92 | — |
| color layer | | | | | |
| Thickness (μm) of organic | 2.90 | 4.30 | — | — | 2.29 |
| ink layer | | | | | |
| Surface roughness Ra (μm) | 0.12 | 0.10 | — | — | — |
| of organic ink layer on | | | | | |
| ceramic color layer | | | | | |
| Surface roughness Ra (μm) | 0.35 | 0.54 | 0.31 | 0.52 | — |
| of ceramic color layer on | | | | | |
| glass plate | | | | | |
| Surface roughness Ra (μm) | 0.01 | 0.02 | — | — | 0.02 |
| of organic ink layer on | | | | | |
| glass plate | | | | | |
| Static load strength (MPa) | 113 | 127 | 86 | 84 | 265 |

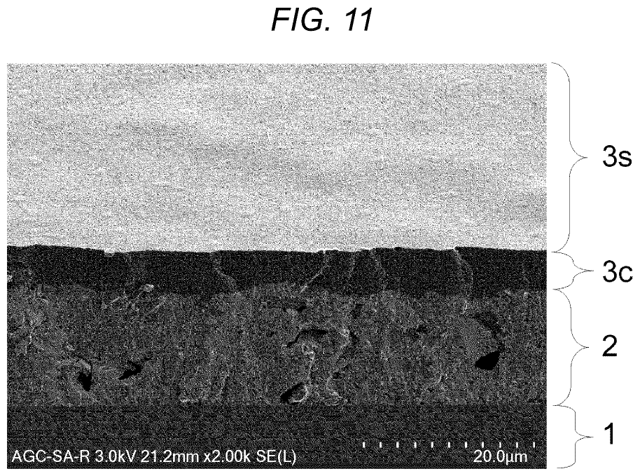

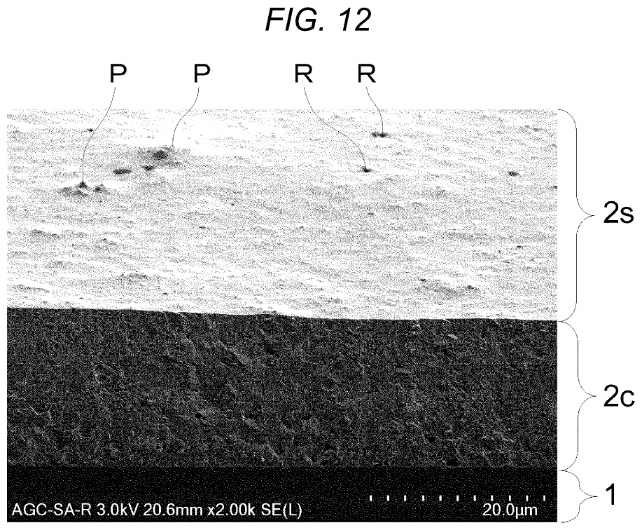

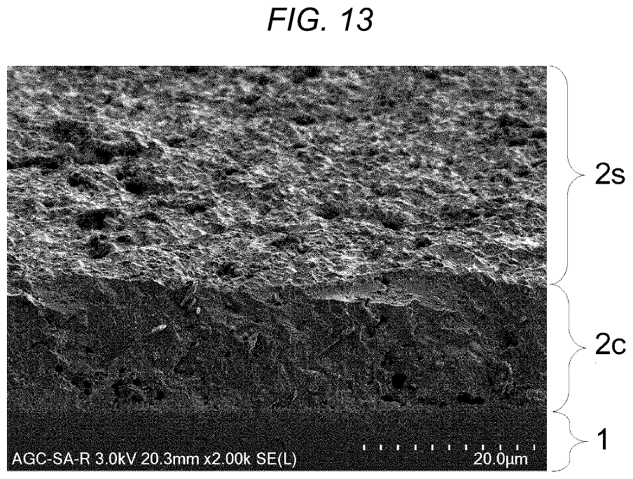

According to the surface property observation using FE-SEM, recessed portions R and protruded portions P were observed on a surface 2s of the ceramic color layer in Example 3 in FIG. 12, while a surface 3s of the organic ink layer was very smooth, and no conspicuous recessed portions or protruded portions were observed in Example 1 in FIG. 10 in which the organic ink layer was provided. The surface 2s of the ceramic color layer was uneven overall in Example 4 in FIG. 13, while the surface 3s of the organic ink layer was very smooth, and no conspicuous recessed portions or protruded portions were observed in Example 2 in FIG. 11 in which the organic ink layer was provided.

Quantitatively, the surface roughness Ra of the ceramic color layer A in Example 3 was 0.31 μm, and the surface roughness Ra of the ceramic color layer A before being covered with the organic ink layer in Example 1 was 0.35 μm; while the surface roughness Ra of the organic ink layer covering the ceramic color layer A in Example 1 was 0.12 μm.

In addition, the surface roughness of the ceramic color layer B in Example 4 was 0.52 μm, and the surface roughness Ra of the ceramic color layer B before being covered with the organic ink layer in Example 2 was 0.54 μm; while the surface roughness Ra of the organic ink layer covering the ceramic color layer B in Example 2 was 0.10 μm.

In this way, it can be seen that by providing the organic ink layer, the surface was very smooth.

The static load strength of the window glass for a vehicle is improved in Example 1 compared to Example 3, and improved in Example 2 compared to Example 4. Accordingly, it can be seen that by further providing an organic ink layer on the ceramic color layer, a decrease in strength of the window glass for a vehicle can be prevented.

Although the present invention has been described in detail with reference to specific embodiments, it is apparent to those skilled in the art that various changes and modifications can be made without departing from the spirit and scope of the present invention. The present application is based on a Japanese Patent Application (No. 2021-165065) filed on Oct. 6, 2021, and the contents thereof are incorporated herein by reference.

### REFERENCE SIGNS LIST

1: glass plate
1a: first main surface
1b: second main surface
1A: outer peripheral end of first main surface of glass plate
2: ceramic color layer
2A: outer peripheral end of ceramic color layer
2s: surface of ceramic color layer
2c: cross section of ceramic color layer
3: organic ink layer
3s: surface of organic ink layer
3c: cross section of organic ink layer
10: window glass for vehicle
R: recessed portion
P: protruded portion

What is claimed is:

1. A window glass for a vehicle comprising:
a glass plate having a first main surface and a second main surface;
a ceramic color layer; and
an organic ink layer,
wherein the ceramic color layer is provided at least in a periphery on the first main surface of the glass plate,
the organic ink layer is provided to cover at least a partial region on the ceramic color layer provided in the periphery, and
a thickness of the organic ink layer is smaller than a thickness of the ceramic color layer.

2. The window glass for a vehicle according to claim 1, wherein the ceramic color layer has a surface roughness Ra of 0.25 μm or more.

3. The window glass for a vehicle according to claim 1, wherein the glass plate has a curved surface shape in which the first main surface is concave, and
the organic ink layer is provided to further cover a partial region on the first main surface of the glass plate, as well as a boundary portion between the glass plate and the ceramic color layer provided in the periphery.

4. The window glass for a vehicle according to claim 1, wherein an outer edge region where the ceramic color layer is not formed is present between an outer peripheral end of the first main surface of the glass plate and an outer peripheral end of the ceramic color layer provided in the periphery, and
the organic ink layer is provided in the outer edge region.

5. The window glass for a vehicle according to claim 1, wherein the thickness of the ceramic color layer is 6 μm to 30 μm, and
the thickness of the organic ink layer is 1 μm to 10 μm.

6. The window glass for a vehicle according to claim 1, wherein the window glass is configured to be disposed in a vehicle such that the first main surface of the glass plate is on a vehicle inner side and the second main surface of the glass plate is on a vehicle outer side.

7. A laminated glass for a vehicle comprising:
the window glass for a vehicle according to claim 1.

8. A windshield for a vehicle comprising:
the window glass for a vehicle according to claim 1.

9. A windshield for a vehicle comprising:
the laminated glass for a vehicle according to claim 7.

10. A method for manufacturing a window glass for a vehicle, sequentially comprising:
preparing a glass plate having a first main surface and a second main surface;
applying a pasty ceramic color composition to at least a periphery on the first main surface of the glass plate and performing a heat treatment to form a ceramic color layer; and
applying an organic ink composition to cover at least a partial region on the ceramic color layer provided in the periphery, and curing the organic ink composition to form an organic ink layer,
wherein the organic ink composition is applied such that a thickness of the organic ink layer is smaller than a thickness of the ceramic color layer.

11. The method for manufacturing a window glass for a vehicle according to claim 10, wherein the heat treatment is performed at a firing temperature equal to or higher than an annealing point of the glass plate while the glass plate is also bent and molded.

12. The method for manufacturing a window glass for a vehicle according to claim 10, wherein the organic ink layer is formed to also cover a partial region on the first main surface of the glass plate, as well as a boundary portion between the glass plate and the ceramic color layer provided in the periphery.

13. The method for manufacturing a window glass for a vehicle according to claim 10, wherein the organic ink composition is applied by an inkjet printing.

14. The method for manufacturing a window glass for a vehicle according to claim 10, wherein the ceramic color layer is formed such that an outer edge region where the ceramic color layer is not formed is present between an outer peripheral end of the first main surface of the glass plate and an outer peripheral end of the ceramic color layer, and
the organic ink layer is formed in the outer edge region.

15. The method for manufacturing a window glass for a vehicle according to claim 10, wherein the organic ink layer is formed by thermal curing or photocuring of the organic ink composition.

16. The method for manufacturing a window glass for a vehicle according to claim 10, wherein the organic ink layer is formed by thermal curing of the organic ink composition, and
the thermal curing is performed at a heat treatment temperature lower than the firing temperature equal to or higher than the annealing point of the glass plate.
